(19) United States
(12) Patent Application Publication
(10) Pub. No.: US 2026/0312636 A1
(43) Pub. Date: Oct. 8, 2026

(54) TECHNIQUES FOR SUPPORTING COHERENT JOINT TRANSMISSION WITH MULTIPLE TRANSMISSION AND RECEPTION POINTS

(71) Applicant: Apple Inc., Cupertino, CA (US)

(72) Inventors: Haitong SUN, Saratoga, CA (US); Dawei ZHANG, Saratoga, CA (US); Dan WU, Beijing (CN); Wei ZENG, Saratoga, CA (US); Weidong YANG, San Diego, CA (US); Ankit BHAMRI, Haar (DE)

(21) Appl. No.: 19/482,705

(22) PCT Filed: May 11, 2023
(86) PCT No.: PCT/CN2023/093472

§ 371 Date: Nov. 7, 2025

(51) Int. Cl. H04B 7/0417; H04B 7/024; H04B 7/06

(52) U.S. Cl. CPC H04B 7/0417; H04B 7/024; H04B 7/0626

(57) ABSTRACT

Techniques for supporting multi-TRP CJT are described. More specifically, in the context of multiple transmission and reception point (TRP) coherent joint transmissions (CJTs), embodiments are directed to one or more of handling different delays for different TRPs/TRP groups, minimizing channel state information (CSI) overhead, and codebook subset restriction (CBSR). For example, indications of which TRPs and/or TRP groups should utilize a common correction factor or different correction factors may be utilized to reduce overhead. In another example, indications of which TRPs and/or TRP groups should utilize a common correction factor or different correction factors may be utilized to reduce overhead. In yet another example, support for restricting spatial bases for which a UE will search and/or report CSI information using one or more CBSRs for various TRPs. Additionally, design details for codebook refinements to support these features are provided.

### FIELD OF INVENTION

This disclosure related generally to wireless technology and more particularly to supporting coherent joint transmission (CJT) with multiple transmission and reception points (TRPs).

### BACKGROUND

In telecommunications, 5G is the fifth-generation technology standard for broadband cellular networks. Like its predecessors, 5G networks are cellular networks, in which the service area is divided into small geographical areas called network cells (or cells). The 3rd Generation Partnership Project (3GPP) is the industry consortium that sets standards for 5G. One of the techniques supported by 5G includes multiple-input and multiple-output (MIMO). MIMO refers to methods for multiplying the capacity of a radio link using multiple transmission and receiving antennas to exploit multipath propagation. MIMO methods can utilize precoding, which is a generalization of beamforming to support multi-stream (or multi-layer) transmission in multi-antenna wireless communications. One technique enabled, at least in part, by MIMO and precoding is coherent joint transmissions. Coherent joint transmission (CJT) refers to where multiple transmitters send a common message with phase constructively combined at a receiver. The transmitters that send the common message may be referred to as transmission and reception points (TRPs).

### BRIEF SUMMARY

Processes, machines, and articles of manufacture for supporting CJT with multiple TRPs (also referred to as multi-TRP CJT) are described. It will be appreciated that the embodiments may be combined in any number of ways without departing from the scope of this disclosure.

Embodiments may include identifying channel state information (CSI) corresponding to a user equipment (UE); determining one or more channel properties of a channel based on the CSI, the channel for utilization by a transmission and reception point (TRP) in a coherent joint transmission (CJT) performed by a plurality of TRP; selecting an intermediate frequency basis of the channel, the intermediate frequency basis selected based on a codebook and the one or more channel properties; selecting a correction factor for the intermediate frequency basis of the channel based on the codebook and the one or more channel properties, the correction factor to adapt the channel for the CJT based on a signal propagation time of the channel; and generating a precoding matrix for the channel based on the intermediate frequency basis and the correction factor.

Embodiments may include identifying codebook subset restriction (CBSR) data corresponding to a coherent joint transmission (CJT) associated with a plurality of transmission and reception points (TRPs); determining, based on the CBSR data, a subset of a set of spatial bases corresponding to a first TRP of the plurality of TRPs; and identifying a signal from the TRP based on a search of the subset of the set of spatial bases.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry according to some embodiments.

FIG. 6 illustrates an example block diagram of a network message according to some embodiments.

FIG. 7 illustrates an exemplary operating environment for determining channel state information (CSI) according to some embodiments.

FIG. 8 illustrates exemplary operating environment for multi-TRP coherent joint transmissions (CJTs) according to some embodiments.

FIG. 9 illustrates example block diagrams of antenna arrays comprising transmission reception points (TRPs) according to some embodiments.

FIGS. 10A and 10B illustrate various aspects of codebook subset restriction (CBSR) according to some embodiments.

FIG. 11 illustrates a logic flow of an exemplary technique associated with multi-TRP CJTs according to some embodiments.

FIG. 12 illustrates a logic flow of an exemplary technique associated with CBSRs according to some embodiments.

### DETAILED DESCRIPTION

Techniques for supporting coherent joint transmission (CJT) with multiple transmission and reception points (TRPs) are described. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etcetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Generally, this disclosure describes techniques for supporting multi-TRP CJT. More specifically, in the context of multi-TRP CJT, embodiments are directed to one or more of handling different delays for different TRPs/TRP groups, minimizing channel state information (CSI) overhead, and codebook subset restriction (CBSR).

Many embodiments are directed to handling different delays for different TRPs/TRP groups in multi-TRP CJTs. Many such embodiments provide design details for codebook refinements to support handling of different delays for different TRPs/TRP groups utilized to perform a multi-TRP CJT. For example, a correction factor may be applied to an intermediate frequency basis selection to compensate for different propagation times for different TRPs utilized to perform a multi-TRP CJT. In several embodiments, the correction factor may comprise a phase ramp in frequency. In several such embodiments, the correction factor may comprise a diagonal matrix of phase ramp terms.

Various embodiments are directed to techniques for minimizing CSI overhead needed to perform multi-TRP CJTs. Various such embodiments provide design details for codebook refinements to minimize CSI overhead required for performing multi-TRP CJTs. For example, indications of which TRPs and/or TRP groups should utilize a common correction factor or different correction factors may be utilized to reduce overhead. In some such examples, UEs may provide indications of which TRP or TRP groups need independent delay and/or frequency basis selection. In another example, relative reporting of various parameters, such as delays and/or correction factors, in CSI reports may be utilized to reduce overhead (e.g., relative to a reference TRP utilized in the multi-TRP CJT). In yet another example, indications of whether different CBSRs should be configured for different TRPs may be utilized to reduce overhead.

Several embodiments are directed to CBSR techniques for multi-TRP CJTs. Several such embodiments, provide design details for codebook refinements to support restricting spatial basis for which a UE will search and/or report CSI information. In some embodiments, CBSRs may indicate an amount of energy a UE should utilize to search various spatial bases. In many embodiments, different CBSRs may be utilized for different combinations of TRPs.

It will be appreciated that various aspects of telecommunication networks, capabilities, protocols, codebooks, and procedures relevant to the techniques described and terms referenced herein can be found in 3GPP technical specifications (TS), such as TS 38.214 and TS 38.331.

The subject matter described hereby provides many technical advantages. For instance, the computer-based techniques of the current disclosure improve the functioning of a telecommunications system as compared to conventional approaches because the techniques enable robust support for multi-TRP CJTs that can improve accessibility and coverage of telecommunication networks, reduce overhead, and provide expanded capabilities versus conventional approaches. For example, the disclosed techniques may support one or more of handling different delays for different TRPs/TRP groups, minimizing channel state information (CSI) overhead, and codebook subset restriction (CBSR) for multi-TRP CJTs. Accordingly, embodiments disclosed hereby can be practically utilized to improve the functioning of a computer and/or to improve the technical fields of telecommunications, 5G networks, MIMO, and/or CJTs.

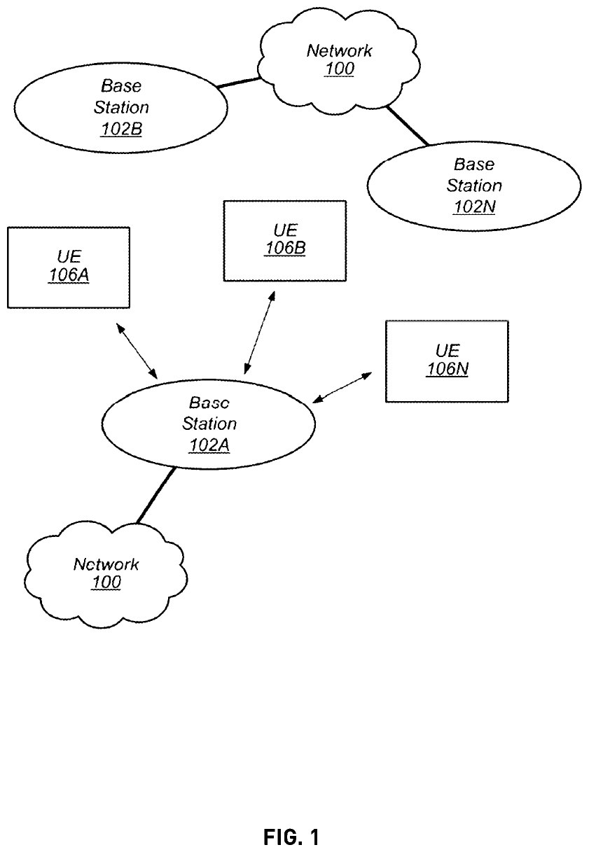

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etcetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etcetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etcetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

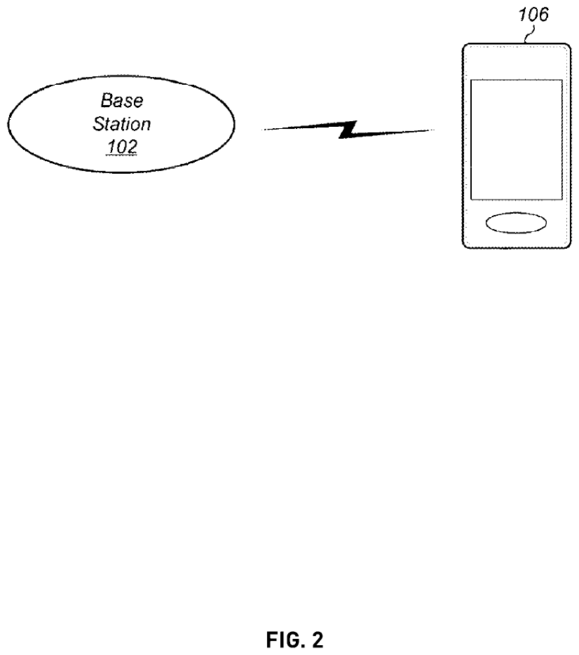

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/eHRPD), or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

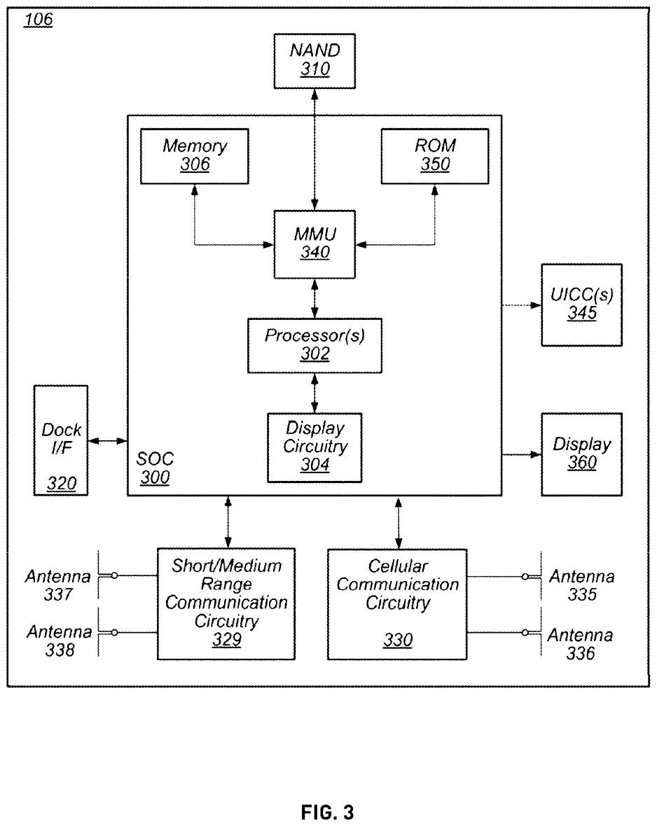

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338.

The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT (e.g., 5G NR, 4G LTE, Bluetooth, Wi-Fi, etcetera) and transmit an indication that the wireless device is capable of maintaining substantially concurrent connections with the first network node and a second network node that operates according to the second RAT (e.g., 5G NR, 4G LTE, Bluetooth, Wi-Fi, etcetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for supporting multi-TRP CJT. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etcetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etcetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etcetera) configured to perform the functions of short range wireless communication circuitry 329.

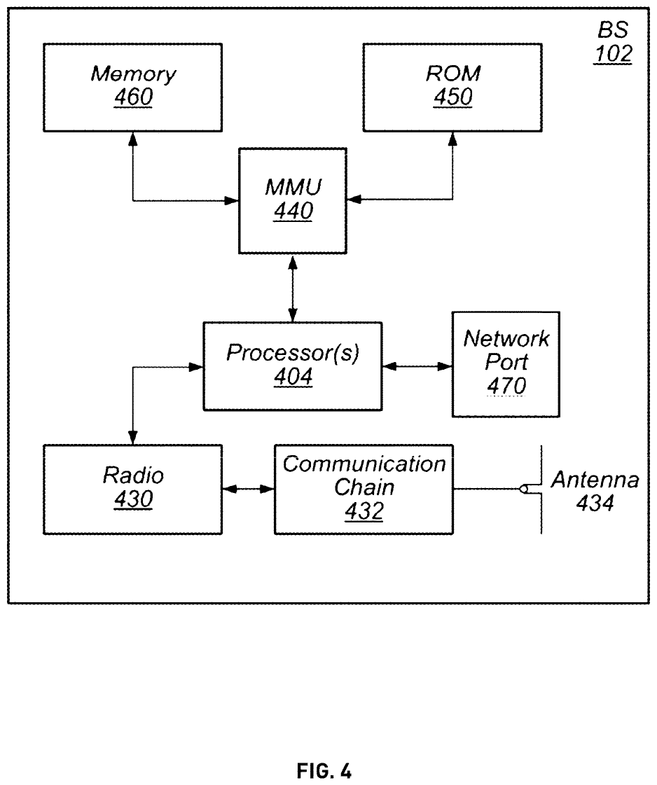

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

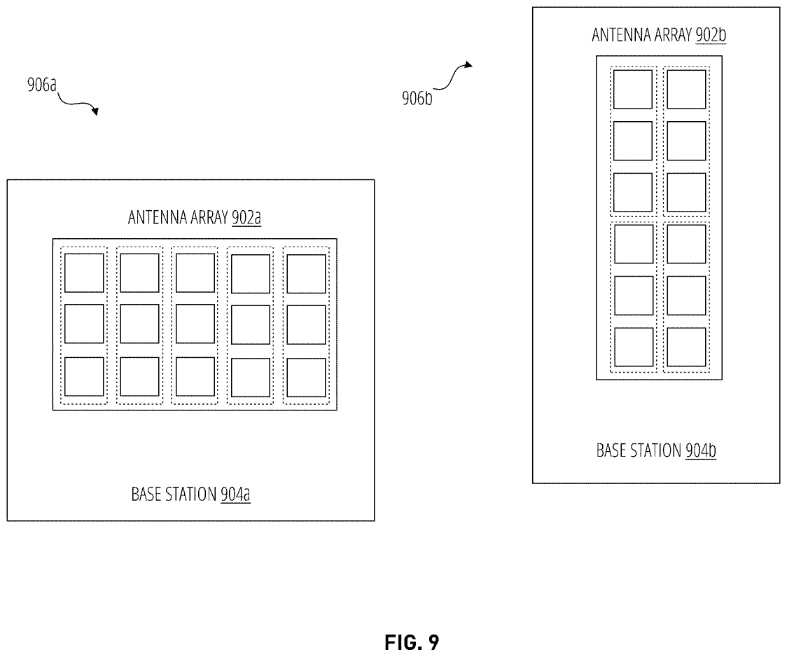

The base station 102 may include at least one antenna 434, and possibly multiple antennas, such as an array of antennas (see e.g., FIG. 9). The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

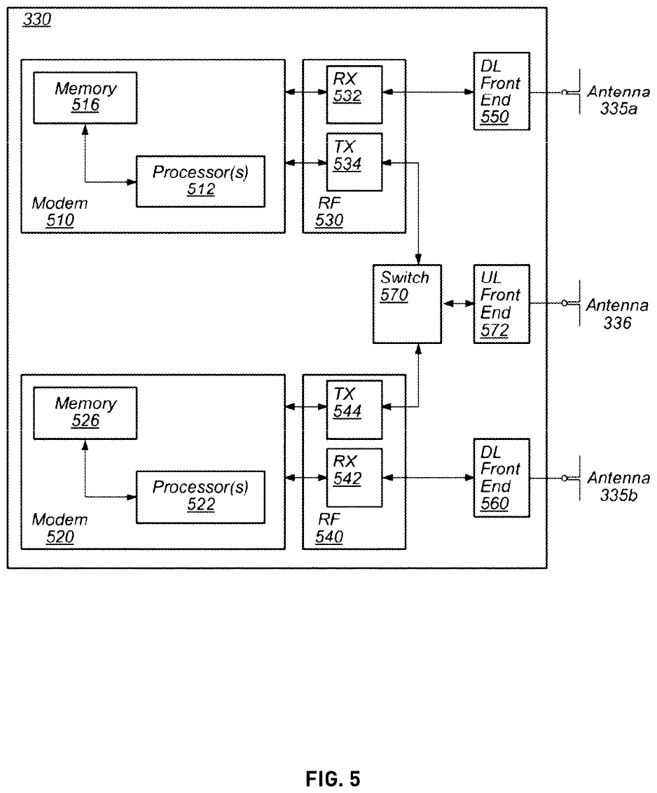

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting multi-TRP CJT, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etcetera) configured to perform the functions of processors 512.

As described herein, the modem 520 may include hardware and software components for implementing the above features for supporting multi-TRP CJT, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etcetera) configured to perform the functions of processors 522.

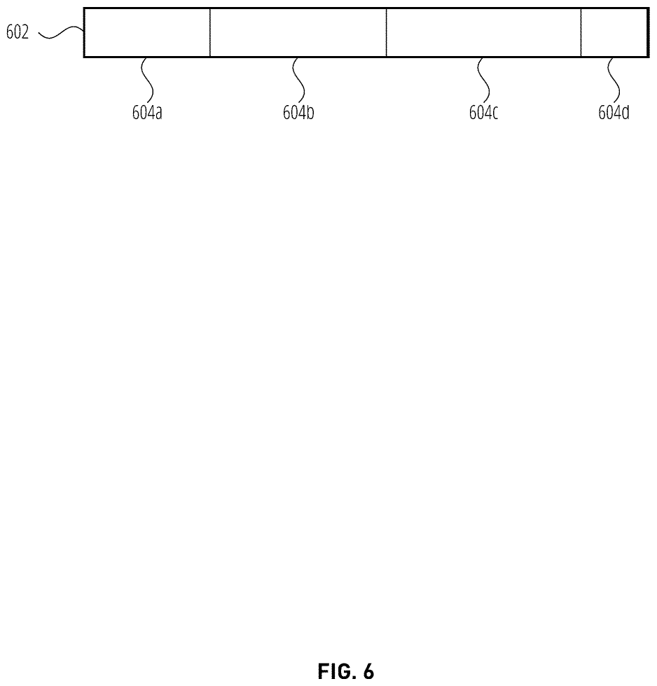

FIG. 6 illustrates a network message 602 comprising a plurality of information elements (IEs) 604a, 604b, 604c, 604d (collectively referred to as IEs 604). In various embodiments, a variety of network messages 602 composed of one or more information elements may be utilized for communication between different components. In various such embodiments, one or more network messages 602 of one or more formats may be exchanged between the one or more UEs and one or more network components to perform one or more procedures or techniques disclosed hereby. For example, the acquisition of channel state information (CSI) may involve the exchange of several network messages 602 between UEs and TRPs. Further, multi-TRP CJTs may be utilized to communicate various network messages 602 to UEs. It will be appreciated that the network message 602 and IEs 604 may come in a variety of formats and carry a variety of information. Oftentimes, various standards and technical specifications define the various network messages 602, IEs 604, and procedures, such as 3GPP technical specifications (e.g., TS 38.214 and TS 38.331). Embodiments are not limited in this context.

Various techniques for supporting multi-TRP CJT in cellular networks will be described in more detail below. More specifically, techniques for handling different delays for different TRPs/TRP groups, minimizing channel state information (CSI) overhead, and codebook subset restriction (CBSR) will be described in more detail below. In many embodiments, the techniques are directed to codebook refinements/improvement associated with multi-TRP CJTs. In many such embodiments, the codebook comprises a Type II MIMO codebook or an enhanced Type II MIMO codebook. The codebook may be configured to support multi-TRP CJTs with a two codebook structure (e.g., mode 1 and mode 2). The mode 1 codebook structure may include a more general codebook structure that is able to handle non-collocated TRPs, such as by supporting independent frequency basis selection for different TRPs/TRP groups. The mode 2 codebook structure may include a simpler codebook structure (i.e., special case of mode 1 for collocated TRPs), such as by using a common frequency basis selection for all TRPs/TRP groups.

Many embodiments enable multi-TRP CJTs when different TRPs/TRP groups have different delays (e.g., due to being in different locations). Many such embodiments provide design details for codebook refinements to support handling of different delays for different TRPs/TRP groups utilized to perform a multi-TRP CJT. For example, a correction factor may be applied to an intermediate frequency basis selection to compensate for different propagation times for different TRPs utilized to perform a multi-TRP CJT. In several embodiments, the correction factor may comprise a phase ramp in frequency. In several such embodiments, the correction factor may comprise a diagonal matrix of phase ramp terms.

Various embodiments minimize CSI overhead needed to perform multi-TRP CJTs. Various such embodiments provide design details for codebook refinements to minimize CSI overhead required for performing multi-TRP CJTs. For example, indications of which TRPs and/or TRP groups should utilize a common correction factor or different correction factors may be utilized to reduce overhead. In some such examples, UEs may provide indications of which TRP or TRP groups need independent delay and/or frequency basis selection. More generally, in various embodiments, CSI may refer to one or more portions of the estimation and acquisition of channel knowledge at both the TRPs (e.g., BSs) and UE. In another example of reducing CSI overhead, relative reporting of various parameters, such as delays and/or correction factors, in CSI reports may be utilized (e.g., relative to a reference TRP utilized in the multi-TRP CJT). In yet another example, indications of whether different CBSRs should be configured for different TRPs may be utilized to reduce overhead.

Several embodiments include CBSR techniques for multi-TRP CJTs. Several such embodiments, provide design details for codebook refinements to support restricting spatial basis for which a UE will search and/or report CSI. In some embodiments, CBSRs may indicate an amount of energy a UE should utilize to search various spatial bases. In many embodiments, different CBSRs may be utilized for different combinations of TRPs.

The computer-based techniques of the current disclosure improve the functioning of a telecommunications system as compared to conventional approaches because the techniques enable robust support for multi-TRP CJTs that can improve accessibility and coverage of telecommunication networks, reduce overhead, and provide expanded capabilities versus conventional approaches. For example, the disclosed techniques may support one or more of handling different delays for different TRPs/TRP groups, minimizing channel state information (CSI) overhead, and codebook subset restriction (CBSR) for multi-TRP CJTs. Accordingly, embodiments disclosed hereby can be practically utilized to improve the functioning of a computer and/or to improve the technical fields of telecommunications, 5G networks, MIMO, and/or CJTs.

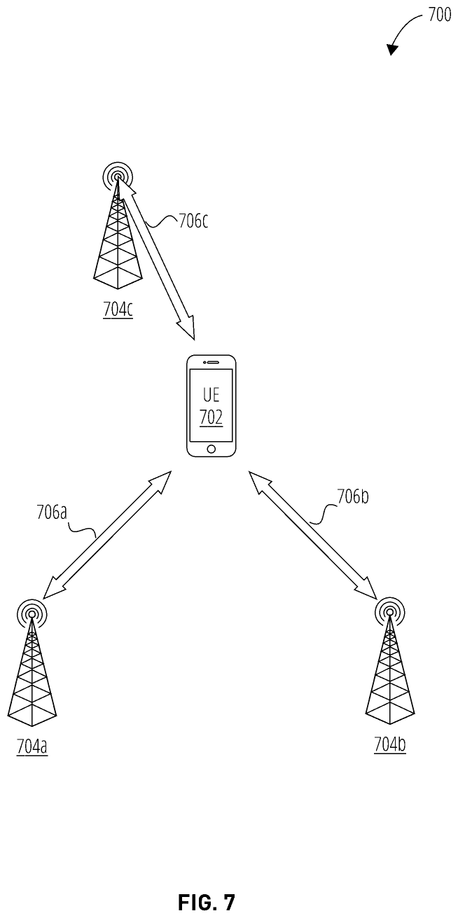

FIG. 7 illustrates an exemplary operating environment 700 for determining channel state information (CSI) according to some embodiments. Operating environment 700 includes a UE 702 and TRPs 704a, 704b, 704c (collectively referred to as TRPs 704). The UE 702 and each of TRPs 704 may exchange signals to estimate, establish, and/or refine channels 706a, 706b, 706c (collectively referred to as channels 706) between the UE 702 and each of the TRPs 704a, 704b, 704c, respectively. For example, the UE 702 may measure and report on various signals generated by the TRPs 704 to provide CSI corresponding to each of the channels 706. In various embodiments described hereby, these channels 706 and the corresponding CSI may be utilized to perform one or more multi-TRP CJTs. Embodiments are not limited in this context.

The CSI report may include three components: (1) a rank indicator (RI), (2) a precoding matrix identifier (PMI), and (3) a channel quality indicator (CQI). In various embodiments, the UE 702 may transmit a CSI report in two parts. In various such embodiments, the first part of the CSI report may dictate the size of the second part of the CSI report. Some embodiments described hereby may exploit this fact to reduce CSI overhead. For example, UE 702 may report whether or not independent delay (requiring independent correction factor selection) and/or frequency selection is required for different TRPs in the first part of the report. In such example, when an independent delay and/or frequency selection is not needed, the corresponding CSI that would be used to select the correction factor and/or frequency is not reported in the second part of the CSI report, thereby reducing the CSI overhead. In many embodiments, the corresponding measurements may not be performed by the UE either, further improving system efficiency.

More generally, in many embodiments, the CSI may be utilized in precoding. Precoding may refer to a generalization of beamforming to support multi-stream (or multi-layer) transmission in multi-antenna wireless communications. Accordingly, various embodiments may utilize CSI in combination with the codebook to configure various precoding parameters. For example, the frequency basis selection and correction factor selection may comprise configuring precoding parameters. In many such embodiments, a precoding matrix may be generated and/or determined as part of configuring the precoding parameters. In several embodiments, the precoding matrix, W, and the codebook are based on a W₁*W₂*W_{f} structure such that

$$W = {W}_{1} * {W}_{2} * {W}_{f} \qquad Equation 1$$

W₁ may refer to the spatial basis selection (e.g., spatial properties of the channel), W₂ may refer to the combination coefficient (e.g., compressed combination coefficients for the channel), and W_{f} may refer to the frequency basis selection (e.g., frequency properties of the channel). As discussed in more detail below, in many embodiments, the correction factor utilized to compensate for handling TRPs with different time delays may be applied to the frequency basis selection, such as via a phase ramp term (see e.g., Equation 7). More generally, the precoding matrix, W, corresponding to a layer index, [symbol] , may be defined by

$${W}^{ℓ} = [ {w}^{ℓ} ( 1 ) … {w}^{ℓ} ( {N}_{3} ) ] \qquad Equation 2$$

N₃ may refer to the number of sub bands in the frequency domain (i.e., the length (number of entries) in each frequency bus). In other words, N₃ may refer to the length of the frequency basis (i.e., the number of PMI sub bands). The spatial basis selection, W₁, for the precoding matrix corresponding to the layer index may be defined by

$${W}_{1} = ( \begin{matrix}{v}_{0} … {v}_{L - 1} & \\ & {v}_{0} … {v}_{L - 1}\end{matrix} ) \qquad Equation 3$$

L may refer to the number of selected spatial basis. In some embodiments, the width of the spatial basis selection matrix may be 2 L. The combination coefficient,

$${W}_{2}^{ℓ} ,$$

for the precoding matrix corresponding to the layer index may be defined by

$${W}_{2}^{ℓ} = ( \begin{matrix}{\tilde{c}}_{0 , 1 , ℓ} & … & {\tilde{c}}_{0 , M , ℓ} \\ ⋮ & ⋱ & ⋮ \\ {\tilde{c}}_{2 L - 1 , 1 , ℓ} & … & {\tilde{c}}_{2 L - 1 , M , ℓ}\end{matrix} ) \qquad Equation 4$$

The combination coefficient may comprise a linear combination coefficient for compression, such as by giving different energy and/or weights to different signal components. In some embodiments, the width of the combination coefficient matrix may be M. The frequency basis selection,

$${W}_{f}^{H} ,$$

for the precoding matrix corresponding to the layer index may be defined by

$${W}_{f}^{H} = ( \begin{matrix}{w}_{f , 1}^{H} \\ ⋮ \\ {w}_{f , M}^{H}\end{matrix} ) \qquad Equation 5$$

Combining Equations 2-5 in view of Equation 1 results in

$$[ \begin{matrix}{w}^{ℓ} ( 1 ) & ⋯ & {w}^{ℓ} ( {N}_{3} )\end{matrix} ] = ( \begin{matrix}{v}_{0} ⋯ {v}_{L - 1} & \\ & {v}_{0} ⋯ {v}_{L - 1}\end{matrix} ) ( \begin{matrix}{\tilde{c}}_{0 , 1 , ℓ} & ⋯ & {\tilde{c}}_{0 , M , ℓ} \\ ⋮ & ⋱ & ⋮ \\ {\tilde{c}}_{2 L - 1 , 1 , ℓ} & ⋯ & {\tilde{c}}_{2 L - 1 , M , ℓ}\end{matrix} ) ( \begin{matrix}{w}_{f , 1}^{H} \\ ⋮ \\ {w}_{f , M}^{H}\end{matrix} ) \qquad Equation 6$$

In various embodiments described hereby, to handle different delays from different TRPs/TRP groups in multi-TRP CJTs, the following enhanced frequency basis selection can be configured. In various embodiments, enhanced frequency basis selection may include or refer to applying a correction factor to handle different delays from different TRPs/TRP groups. For the n^{th} TRP, the final l^{th} selected frequency basis,

$${W}_{f}^{n , l} ,$$

may be

$${W}_{f}^{n , l} = diag ( [ \begin{matrix}1 & {e}^{j {ϕ}^{n , l}} & {e}^{2 j {ϕ}^{n , l}} & ⋯ & {e}^{( {N}_{3} - 1 ) j {ϕ}^{n , l}}\end{matrix} ] ) {\tilde{W}}_{f}^{n , l} \qquad Equation 7$$

$${\tilde{W}}_{f}^{n , l}$$

may refer to the intermediate l^{th} selected frequency basis for the n^{th} TRP from the Discrete Fourier Transform (DFT) matrix without oversampling (e.g., rotation),

$$diag ( [ \begin{matrix}1 & {e}^{j {ϕ}^{n , l}} & {e}^{2 j {ϕ}^{n , l}} & ⋯ & {e}^{( {N}_{3} - 1 ) j {ϕ}^{n , l}}\end{matrix} ] ) ,$$

may refer to the correction factor where diag(x) is to create a diagonal matrix from the entries in vector x

$$diag ( [ \begin{matrix}1 & {e}^{j {ϕ}^{n , l}} & {e}^{2 j {ϕ}^{n , l}} & ⋯ & {e}^{( {N}_{3} - 1 ) j {ϕ}^{n , l}}\end{matrix} ] ) ,$$

and φ^{n,l}, may refer to the phase ramp for the l^{th} selected frequency basis for the n^{th} TRP. Accordingly, in various embodiments, the intermediate frequency basis may comprise a DFT matrix. The larger the phase ramp, the larger the compensated time domain delay. In various embodiments, for enhanced frequency basis selection to handle different delays from different TRPs/TRP groups, in terms of intermediate frequency basis selection,

$${\tilde{W}}_{f}^{n , l}$$

there may be two options. In the first option, each TRP may independently select the intermediate frequency basis selection. In the second option, each TRP may select a common intermediate frequency basis

$$( i . e . , {\tilde{W}}_{f}^{{n}_{1} , l} = {\tilde{W}}_{f}^{{n}_{2} , l} , \{ {n}_{1} \neq {n}_{2} ) .$$

In many embodiments, combinations of the first and second options may be utilized. For example, each TRP group may independently select while TRPs within a group utilize a common intermediate frequency basis. In many embodiments, every frequency basis may be a DFT matrix, which results in a linear phase drop. In several embodiments, the DFT basis may be equivalent to the correction factor.

In some embodiments, further restrictions may be utilized for enhanced frequency basis selection to support different delays from different TRPs/TRP groups with minimal overhead. In various embodiments, one or more of the further restrictions may be directed to reducing reporting overhead by having delays/correction factors be relative to a reference TRP. In a first option for further restriction, for each TRP, selection of the first DFT basis may be required. The first DFT basis is a vector of all ones (i.e., DFT₀=[1 1, . . . , 1]), resulting in no delay. In a second option for further restriction, only the reference TRP may be required to select the first DFT basis. In various embodiments, the reference TRP may be fixed to the first one (i.e., n=0). In other embodiments, the reference TRP may be reported by the UE flexibly. For example, the reference TRP may always be the TRP closest to the UE, which may change during mobility. Accordingly, by being relative to a reference TRP reduces overhead by enabling at least one TRP to have no delay.

In various embodiments, for enhanced frequency basis selection to handle different delays from different TRPs/TRP groups, in terms of the phase ramp selection, φ^{n,l}, there may be two options for different frequency basis of the same TRP. In various embodiments, there may be two or more frequency basis in the same TRP. In the first option, each frequency basis selects the same φ^{n,l}

$$( i . e . , for {\tilde{W}}_{f}^{n , {l}_{1}} = {\tilde{W}}_{f}^{n , {l}_{2}} , {l}_{1} \neq {l}_{2} ) .$$

In the second option each frequency basis selects an independent φ^{n,l}. In the first and second options, the system may still adapt for different delays for different TRPs.

For different TRPs, the reference TRP may always assume φ^{n,l}=0, which can be used to reduce overhead because there is no need for the corresponding reporting. In various embodiments, the reference TRP may be fixed to the first one (i.e., n=0). In other embodiments, the reference TRP may be reported by the UE flexibly. For all other TRPs, φ^{n,l} may be reported independently.

In various embodiments, finer grained phase ramp selection may be needed (i.e., more steps between 0 and 2π), such as to ensure vectors are orthogonal for the DFT matrix because orthogonality may also be caused by different phase ramp. In other words, more steps allows orthogonality to be maintained while also using phase ramp to compensate for time delay. Additionally finer grained phase ramp selection may enable finer grained time delay resolution.

For the base unit of φ^{n,l} there may be two options. In the first option, the base unit of φ^{n,l} may be

$$\frac{2 π}{{N}_{3}} ( i . e . , {ϕ}^{n , l} = {c}^{n , l} \frac{2 π}{{N}_{3}} ) .$$

In the second option, the base unit of φ^{n,l} may be

$$\frac{2 π}{{N}_{3} \cdot {O}_{3}} ( i . e . , {ϕ}^{n , l} = {c}^{n , l} \frac{2 π}{{N}_{3} \cdot {O}_{3}} ) .$$

O₃ may refer to the oversampling factor, and a higher oversampling factor may give higher resolution. The oversampling factor can either be configured by the network, reported by the UE in the CSI report, and/or hard coded in the specification (e.g., O₃=4). Option two may provide finer delay resolution than option one; however, option two may require more overhead. This results in a granularity/overhead tradeoff between options one and two. c^{n,l} may refer to the integer value reported by the UE. In a first option. c^{n,l} may be restricted to a non-negative integer (i.e., c^{n,l}=0, 1, . . . , (N₃−1)). In a second option. c^{n,l} may be negative, zero, or positive (i.e., c^{n,l}=−(N₃−1), . . . , −1, 0, 1, . . . , (N₃−1)). However, if the reference TRP is static (as opposed to flexible), then option two needs to be utilized in case the reference TRP is not currently the closest TRP to the UE. If the reference TRP is dynamic, then option one may be utilized. Thus, the first option results in more upfront overhead and reduced overhead later in the process while the second option results in less upfront overhead and increased overhead later in the process.

In some embodiments, in order to reduce CSI overhead, the UE may report whether independent delay and/or frequency basis selection is needed for different TRPs. When the UE reports that independent delay and/or frequency basis selection is needed for different TRPs, one or both of the following assumptions may be made at the network: (1) all φ^{n,l}=0 and (2) each TRP selects the same intermediate frequency basis

$$( i . e . , {\tilde{W}}_{f}^{{n}_{1} , l} = {\tilde{W}}_{f}^{{n}_{2} , l} , \{ {n}_{1} \neq {n}_{2} .$$

This report may be included in the first part of the CSI report. If there is no need for independent delay and/or frequency basis selection, CSI overhead may be reduced by excluding the corresponding report in the second part of the CSI report.

In various embodiments, in order to reduce CSI overhead, the UE may report one or multiple lists of TRPs (i.e., [symbol] ), such as lists of preferred TRPs). This technique may benefit from the fact that the UE has better channel quality knowledge than the network. For all TRPs in the same list of TRPs, one or both of the following assumption may be made at the network: (1) all the φ^{n,l} are the same (i.e., φⁿ^{¹}^{,l}=φⁿ^{²}^{,l}{n₁,n₂}∈ [symbol] ) and (2) each TRP selects the same intermediate frequency basis

$$( i . e . , {\tilde{W}}_{f}^{n , l} = {\tilde{W}}_{f}^{n , l} , \{ {n}_{1} , {n}_{2} \} ∈ ℂ ) .$$

In some embodiments, if one list of TRPs is reported, the network may assume that all the φ^{n,l} corresponding to the TRPs in the reported list are 0 (i.e., φ^{n,l}=0 n∈ [symbol] ). In many embodiments, each list of TRPs may be reported as a bitmap. In some embodiments, the bit width of the bitmap may equal the total number of TRPs (i.e., NZP-CSI-RS-Resource, N_{TRP}). In other embodiments, the bit width of the bitmap may equal the selected number of TRPs (i.e., N≤N_{TRP}). In some embodiments, the lists of TRPs may be reported in CSI part one, enabling the reduction of CSI part two based on the assumptions corresponding to the lists. In one embodiment, all TRPs in a list may serve as reference TRPs.

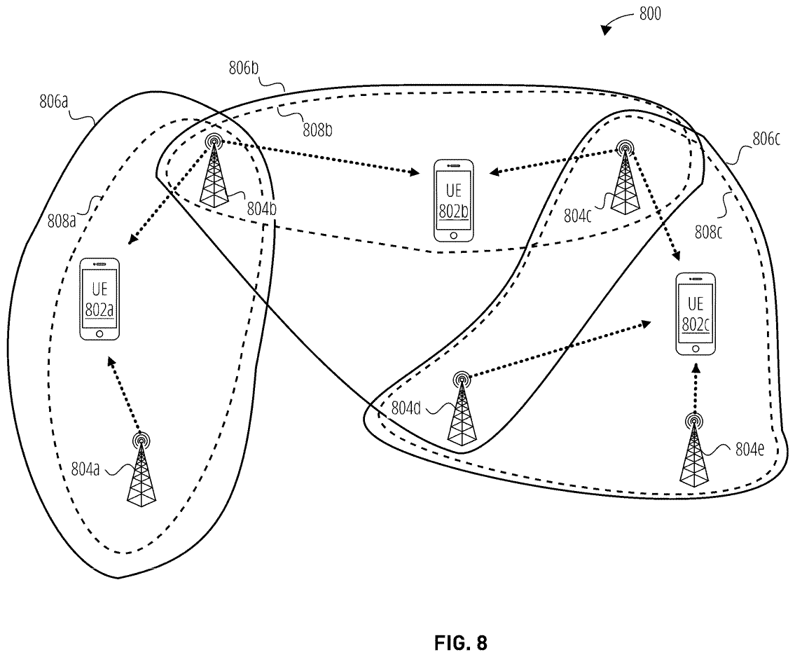

FIG. 8 illustrates an exemplary operating environment 800 for multi-TRP CJTs according to some embodiments. Operating environment 800 includes a plurality of UEs 802a, 802b, 802c (collectively referred to as UEs 802) and a plurality of TRPs 804a, 804b, 804c, 804d, 804e (collectively referred to as TRPs 804). The TRPs may be grouped into various sets, such as by the network based on CSI. These sets may include coordination sets, measurement sets, and CJT sets. TRPs in a coordination set may be presumed to have sufficient backhaul connectivity to support CJT. TRPs in a measurement set are typically measured and reported by a UE (e.g., as part of determining CSI). TRPs in a CJT set are utilized to perform a CJT to a UE. TRPs in the measurement and CJT sets are determined by the network in a UE centric fashion. In some embodiments, one or more sets may be determined by the network based on lists provided by UEs. Oftentimes, the measurement set and the CJT set may include the same set of TRPs. In the illustrated embodiment, all the TRPs 804 may be included in a coordination set. Further, TRP 804a and TRP 804b are included in a measurement set 806a and a CJT set 808a corresponding to UE 802a. TRP 804b, TRP 804c, and TRP 804d are included in a measurement set 806b corresponding to UE 802b and TRP 804b and TRP 804c are in a CJT set 808b corresponding to UE 802b. TRP 804c, TRP 804d, and TRP 804e are included a measurement set 806c and a CJT set 808c corresponding to UE 802c. Embodiments are not limited in this context.

In several embodiments, the network may coordinate the selection of sets and the performance of multi-TRP CJTs based on CSI. In many embodiments, the network may utilize communications with the various TRPs to coordinate and perform multi-TRP CJTs (e.g., via backhaul). In various embodiments, the network may ensure that the phase of the signals received at a UE from TRPs in a corresponding CJT set add up constructively based on the acquired CSI, such as by accounting for different time delays between UEs and TRPs in a CJT set as determined based on measurement reports from the measurement set.

FIG. 9 illustrates example block diagrams of antenna arrays 902a, 902b comprising transmission reception points (TRPs) according to some embodiments. The antenna array 902a is included in a first base station 904a that may comprise one or more TRPs 906a and the antenna array 902b is included in a second base station 904b that may include one or more TRPs 906b. The antenna array 902a includes a plurality of antenna elements, represented as squares, in a 5×3 array that is divided into five 1×3 sub arrays, represented as dotted-line rectangles. The antenna array 902b includes a plurality of antenna elements, represented as squares, in a 2×6 array that is divided into four 1×3 sub arrays, represented as dotted-line rectangles. However, it will be appreciated that the antenna arrays 902a, 902b are merely exemplary and antenna arrays may come in a variety of configurations without departing from the scope of this disclosure. In various embodiments, one or more of the sub arrays in antenna arrays 902a, 902b may comprise a TRP in the one or more TRPs 906a, 906b, respectively. Embodiments are not limited in this context.

As described above, CSI regarding channels between a UE and a TRP may be utilized, such as in precoding, to cause the antenna elements included in the multiple TRPs to transmit a beam of signals to the UE at part of a CJT. The beams may be aimed with respect to two dimensions based on spatial basis selection. In many embodiments, each spatial bases may correspond to an aperture angle or direction. Handling of time delay between different beams in a CJT may be accomplished via phase ramps corresponding to the correction factor. This may include compensating for different time delays between non-collocated TRPs. In some embodiments, different TRPs within a common antenna array may be considered collocated while different TRPs in different antenna arrays may be considered non-collocated. In other embodiments, thresholds may be utilized to determine whether different TRPs should be considered as collocated (e.g., distance between, difference in propagation time, and the like).

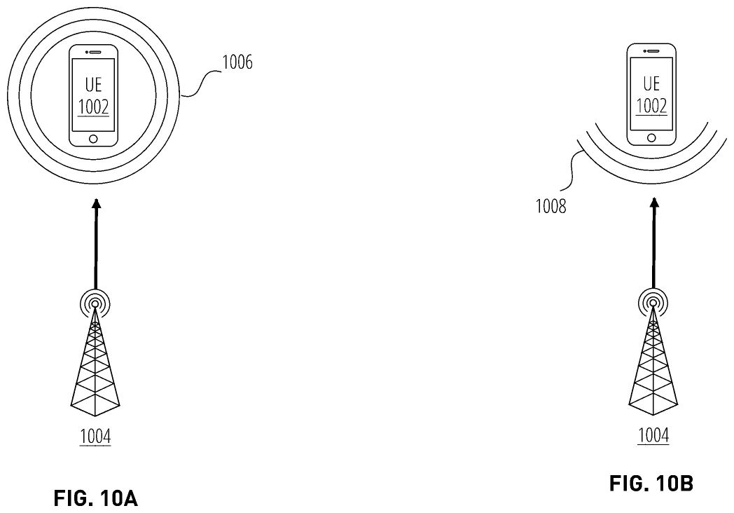

FIGS. 10A and 10B illustrate various aspects of codebook subset restriction (CBSR) according to some embodiments. FIG. 10A illustrates a UE 1002 not utilizing a CBSR and therefore having an unrestricted set 1006 of spatial bases for spatial basis selection with TRP 1004. FIG. 10A illustrates a UE 1002 utilizing a CBSR and therefore having a restricted subset 1008 of spatial bases for spatial basis selection with TRP 1004. Thus, CBSRs may be utilized to improve efficiency and performance by reducing the options in the codebook that must be evaluated (e.g., searched, measured, and/or reported) for spatial basis selection. In many embodiments, CBSRs may comprise bitmaps. Embodiments are not limited in this context.

For multi-TRP CJT, such as for Type II codebook refinement, in terms of CBSR, there may generally be two options. In a first option, the same CBSR may be configured for all TRPs. In a second option, different CBSRs may be configured for different TRPs. As with other scenarios and options described hereby, different options may be applied to different groups of one or more TRPs. For example, option two may provide finer CSBR control than option one; however, option two may require more signaling overhead. This results in a CBSR control/overhead tradeoff between options one and two. Greater CBSR control may allow a TRP to be pointed in more directions and/or support more deployment scenarios. In various embodiments, each independent CBSR may require between 15 and 20 bits (e.g., 17 bits) of additional overhead in the CSI report.

For each CBSR configuration of a TRP, it may include one or multiple beam groups. For each beam group, the CBSR may include two components: (1) a selected rotation factor and/or, (2) for the selected rotation factor, the restriction on each spatial basis. For a selected rotation factor, there may be a total of N₁*N₂ spatial basis, where N₁ is the number of antenna elements in the beam group in the horizontal direction and N₂ is the number of antenna elements in the beam group in the vertical direction (see e.g., FIG. 8). Further, in various embodiments, N₁*N₂=P/2 in which P is the number of NZP-CSI-RS-Resource ports for the corresponding TRP. In various embodiments, oversampling may be utilized to achieve finer spatial resolution for CBSRs (similar to achieving finer delay resolution through finer phase ramp granularity). For the selected rotation factor of each beam group, one rotation factor may be selected from O₁*O₂ rotation factors. O₁ may correspond to the oversampling factor horizontally and O₂ may correspond to the oversampling factor vertically. Higher the oversampling factors may result in finer spatial resolution. In some embodiments, O₁=4 if there are more than one antenna element horizontally, otherwise O₁=1. Similarly, O₂=4 if there are more than one antenna element vertically, otherwise O₂=1. For the restriction on each spatial basis for a selected rotation factor of each beam group, restrictions of each of N₁*N₂ spatial basis may be configured based on one or two bits (e.g., in the bitmap). When a single bit is used, 0 may indicate that the corresponding spatial basis cannot be selected and 1 may indicate that the corresponding spatial basis can be selected. When two bits are used, four possible values may be used to restrict the energy on the corresponding spatial basis. In other words, when two bits are used, an indication of how much energy to spend search a corresponding spatial basis may be included. For example, each of the four values may correspond to an amount of energy to spend between zero and a max energy.

In some embodiments, in order to reduce CSI overhead, the network may configure one or more lists of TRPs for joint CBSRs (similar to UEs configuring TRP lists for independent delay and/or frequency basis selection). In various embodiments, for each list of TRPs, the network only configures one CBSR and for all TRPs in the same list, the UE assumes the same CBSR configuration applies. This technique may benefit from the fact that the gNB has better knowledge than the UE on where the TRP is located.

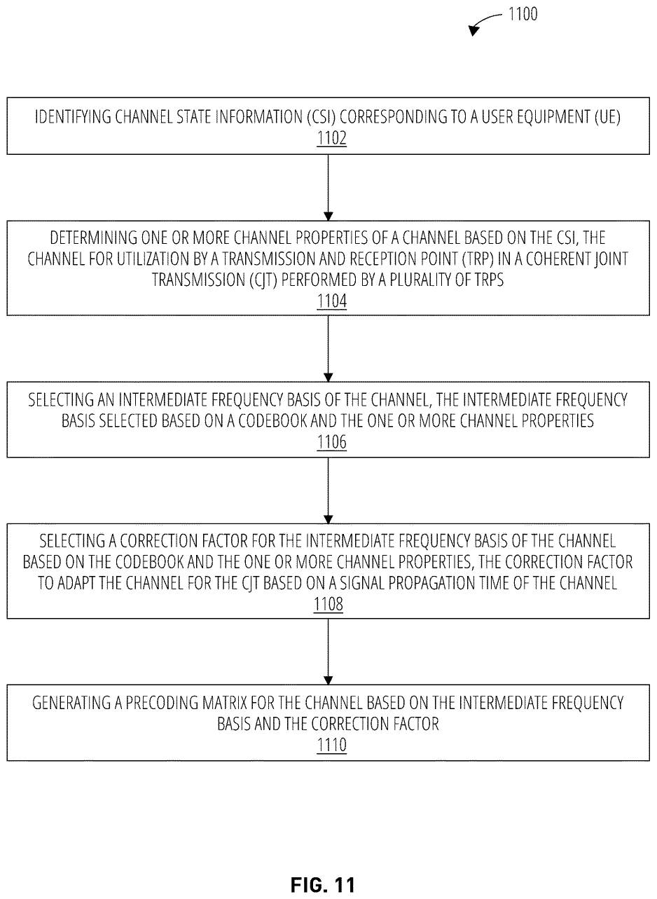

FIG. 11 illustrates a logic flow 1100 of an exemplary technique associated with multi-TRP CJTs according to some embodiments. Aspects of logic flow 1100 may relate to various embodiments described hereby. Logic flow 1100 may begin at block 1102. Block 1102 may include identifying channel state information (CSI) corresponding to a user equipment (UE). For example, the network may identify channel state information received from a UE. Proceeding to block 1104, one or more channel properties of a channel may be determined based on the CSI. Further, the channel may be for utilization by a transmission and reception point (TRP) in a coherent joint transmission (CJT) performed by a plurality of TRPs. For example, the properties of channel 706a may be determined based on CSI for utilization by TRP 704a in a CJT performed by TRPs 704a, 704b, 704c.

Continuing to block 1106, an intermediate frequency basis of the channel may be selected based on a codebook and the one or more channel properties. For example,

$${\tilde{W}}_{f}^{n , l}$$

for channel 706a may be selected based on an enhanced Type II MIMO codebook and the one or more channel properties determined from CSI. At block 1108, a correction factor for the intermediate frequency basis of the channel may be selected based on the codebook and the one or more channel properties. Further, the correction factor may adapt the channel for the CJT based on a signal propagation time of the channel. For example, the correction factor,

$$diag ( [ \begin{matrix}1 & {e}^{j {ϕ}^{n , l}} & {e}^{2 j {ϕ}^{n , l}} & ⋯ & {e}^{( {N}_{3} - 1 ) j {ϕ}^{n , l}}\end{matrix} ] ) ,$$

may be selected based on an enhanced Type II MIMO codebook and the one or more channel properties determined from CSI. Proceeding to block 1110, a precoding matrix for the channel may be generated based on the intermediate frequency basis and the correction factor. For example, a final frequency basis selection for a precoding matrix, W, may be generated based on Equation 7.

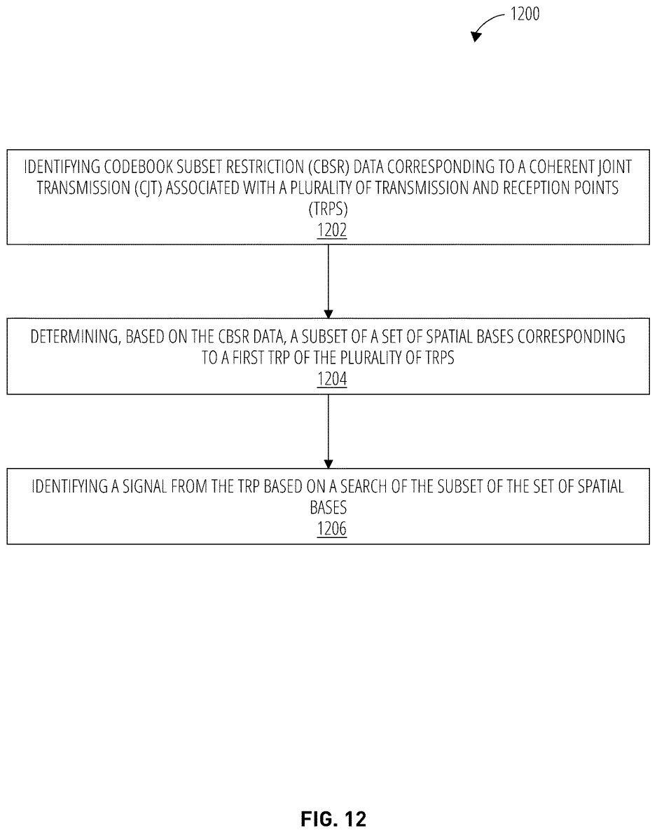

FIG. 12 illustrates a logic flow 1200 of an exemplary technique associated with CBSRs according to some embodiments. Aspects of logic flow 1200 may relate to various embodiments described hereby. Logic flow 1200 may begin at block 1202. Block 1202 may include identifying codebook subset restriction (CBSR) data corresponding to a coherent joint transmission (CJT) associated with a plurality of transmission and reception points (TRPs). For example, UE 802a may receive CBSR data in the form of a bitmap from the network.

Continuing to block 1204, a subset of a set of spatial bases corresponding to a first TRP of the plurality of TRPs may be determined based on the CBSR data. For example, restricted subset 1008 may be determined from unrestricted set 1006 for TRP 1004 based on the CBSR data. Proceeding to block 1206, a signal from the TRP based on a search of the subset of the set of spatial bases may be identified. For example, UE 1002 may identify a signal from TRP 1004 based on a search of restricted subset 1008.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etcetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a computer-implemented method, comprising: identifying channel state information (CSI) corresponding to a user equipment (UE); determining one or more channel properties of a channel based on the CSI, the channel for utilization by a transmission and reception point (TRP) in a coherent joint transmission (CJT) performed by a plurality of TRP; selecting an intermediate frequency basis of the channel, the intermediate frequency basis selected based on a codebook and the one or more channel properties; selecting a correction factor for the intermediate frequency basis of the channel based on the codebook and the one or more channel properties, the correction factor to adapt the channel for the CJT based on a signal propagation time of the channel; and generating a precoding matrix for the channel based on the intermediate frequency basis and the correction factor.

Example 2 is the computer-implemented method of Example 1 that may optionally include that the correction factor includes a phase ramp corresponding to a delay in time of the signal propagation time of the channel relative to another TRP in the plurality of TRPs.

Example 3 is the computer-implemented method of Example 1 that may optionally include that the correction factor comprises a diagonal matrix of phase ramp terms.

Example 4 is the computer-implemented method of Example 1 that may optionally include that the codebook comprises a Type II multiple-input multiple-output codebook.

Example 5 is the computer-implemented method of Example 1 that may optionally include selecting the plurality of TRPs for performance of the CJT based on an indication in a CSI report from the UE.

Example 6 is the computer-implemented method of Example 1 that may optionally include that the TRP comprises a first TRP and comprising utilizing the correction factor for a second TRP in the plurality of TRPs based on selection of the intermediate frequency basis for usage by the first and second TRPs.

Example 7 is the computer-implemented method of Example 1 that may optionally include utilizing the intermediate frequency basis and the correction factor for another TRP in the plurality of TRPs based on an indication in a CSI report from the UE.

Example 8 is the computer-implemented method of Example 1 that may optionally include selecting the TRP as a reference TRP from the plurality of TRPs, wherein the correction factor comprises a vector of ones in response to selection of the TRP as the reference TRP.

Example 9 is the computer-implemented method of Example 1 that may optionally include providing an indication of a reference TRP in the plurality of TRPs to the UE; and receiving a CSI report from the UE comprising a correction factor indicated relative to the reference TRP.

Example 10 is the computer-implemented method of Example 1 that may optionally include determining a base unit for the correction factor based on a length of a frequency basis, wherein the length of the frequency basis comprises a number of PMI sub bands in the frequency domain.

Example 11 is the computer-implemented method of Example 10 that may optionally include determining the base unit for the correction factor based on the length of the frequency basis and an integer value, wherein the integer value is reported by the UE, configured by a network comprising the TRP, or specified in a specification.

Example 12 is the computer-implemented method of Example 10 that may optionally include determining the base unit for the correction factor based on the length of the frequency basis and an oversampling factor.

Example 13 is the computer-implemented method of Example 1 that may optionally include that the intermediate frequency basis comprises a discrete Fourier transform matrix.

Example 14 is a network comprising one or more processors configured to perform the computer-implemented method of any of Examples 1 to 13.

Example 15 is a non-transitory machine-readable medium having executable instructions to cause one or more processing units to perform the computer-implemented method of any of Examples 1 to 13.

Example 16 is a computer-implemented method comprising identifying codebook subset restriction (CBSR) data corresponding to a coherent joint transmission (CJT) associated with a plurality of transmission and reception points (TRPs); determining, based on the CBSR data, a subset of a set of spatial bases corresponding to a first TRP of the plurality of TRPs; and identifying a signal from the TRP based on a search of the subset of the set of spatial bases.

Example 17 is the computer-implemented method of Example 16 that may optionally include generating a channel state information (CSI) report limited to the subset of the set of spatial bases.

Example 18 is the computer-implemented method of Example 16 that may optionally include that the CBSR data includes a rotation factor and a restriction for each spatial basis associated with the rotation factor.

Example 19 is the computer-implemented method of Example 16 that may optionally include that the CBSR data indicates an amount of energy to utilize searching each spatial basis in the set of spatial bases.

Example 20 is the computer-implemented method of Example 16 that may optionally include the CBSR data comprises a bitmap.

Example 21 is the computer-implemented method of Example 16 that may optionally include that the CBSR data is based on one or more of a horizontal oversampling factor and a vertical oversampling factor.

Example 22 is the computer-implemented method of Example 16 that may optionally include utilizing the subset of the set of spatial bases corresponding to the first TRP with a second TRP in the plurality of TRPs based on a list of TRPs configured by a network comprising the plurality of TRPs.

Example 23 is a user equipment (UE) comprising one or more processors configured to perform the computer-implemented method of any of examples 16 to 22.

Example 24 is a non-transitory machine-readable medium having executable instructions to cause one or more processing units to perform the computer-implemented method of any of examples 16 to 22.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

1. A method for wireless communication by a network, the method comprising:
identifying channel state information (CSI) corresponding to a user equipment (UE);
determining one or more channel properties of a channel based on the CSI, the channel for utilization by a first transmission and reception point (TRP) in a coherent joint transmission (CJT) performed by a plurality of TRPs;
selecting an intermediate frequency basis of the channel, the intermediate frequency basis selected based on a codebook and the one or more channel properties;
selecting a correction factor for the intermediate frequency basis of the channel based on the codebook and the one or more channel properties, the correction factor to adapt the channel for the CJT based on a signal propagation time of the channel; and
generating a precoding matrix for the channel based on the intermediate frequency basis and the correction factor.

2. The method of claim 1, wherein the correction factor includes a phase ramp corresponding to a delay in time of the signal propagation time of the channel relative to another TRP in the plurality of TRPs.

3. The method of claim 1, wherein the correction factor comprises a diagonal matrix of phase ramp terms.

4. The method of claim 1, wherein the codebook comprises a Type II multiple-input multiple-output codebook.

5. The method of claim 1, comprising selecting the plurality of TRPs for performance of the CJT based on an indication in a CSI report from the UE.

6. The method of claim 1, comprising utilizing the correction factor for a second TRP in the plurality of TRPs based on selection of the intermediate frequency basis for usage by the first and second TRPs.

7. The method of claim 1, comprising utilizing the intermediate frequency basis and the correction factor for another TRP in the plurality of TRPs based on an indication in a CSI report from the UE.

8. The method of claim 1, comprising selecting the first TRP as a reference TRP from the plurality of TRPs, wherein the correction factor comprises a vector of ones in response to selection of the first TRP as the reference TRP.

9. The method of claim 1, comprising:
providing an indication of a reference TRP in the plurality of TRPs to the UE; and
receiving a CSI report from the UE comprising a correction factor indicated relative to the reference TRP.

10. The method of claim 1, comprising determining a base unit for the correction factor based on a length of a frequency basis, wherein the length of the frequency basis comprises a number of PMI sub bands in the frequency domain.

11. The method of claim 10, comprising determining the base unit for the correction factor based on the length of the frequency basis and an integer value, wherein the integer value is reported by the UE, configured by a network comprising the TRP, or predefined.

12. The method of claim 10, comprising determining the base unit for the correction factor based on the length of the frequency basis and an oversampling factor.

13-19. (canceled)

20. A method for wireless communication by a user equipment (UE), the method comprising:
identifying codebook subset restriction (CBSR) data corresponding to a coherent joint transmission (CJT) associated with a plurality of transmission and reception points (TRPs);
determining, based on the CBSR data, a subset of a set of spatial bases corresponding to a first TRP of the plurality of TRPs; and
identifying a signal from the first TRP based on a search of the subset of the set of spatial bases.

21. The method of claim 20, comprising generating a channel state information (CSI) report limited to the subset of the set of spatial bases.

22. The method of claim 20, wherein the CBSR data includes a rotation factor and a restriction for each spatial basis associated with the rotation factor.

23. The method of claim 20, wherein the CBSR data indicates an amount of energy to utilize searching each spatial basis in the set of spatial bases.

24. The method of claim 20, wherein the CBSR data comprises a bitmap.

25. The method of claim 20, wherein the CBSR data is based on one or more of a horizontal oversampling factor and a vertical oversampling factor.

26. The method of claim 20, comprising utilizing the subset of the set of spatial bases corresponding to the first TRP with a second TRP in the plurality of TRPs based on a list of TRPs configured by a network comprising the plurality of TRPs.

27. A user equipment (UE) comprising one or more processors configured to perform operations comprising:
identifying codebook subset restriction (CBSR) data corresponding to a coherent joint transmission (CJT) associated with a plurality of transmission and reception points (TRPs);
determining, based on the CBSR data, a subset of a set of spatial bases corresponding to a first TRP of the plurality of TRPs; and
identifying a signal from the first TRP based on a search of the subset of the set of spatial bases.

28-30. (canceled)
